(19) United States
(12) Patent Application Publication
(10) Pub. No.: US 2026/0056835 A1
(43) Pub. Date: Feb. 26, 2026

(54) IN-VEHICLE NETWORK SYSTEM AND MANAGEMENT METHOD OF IN-VEHICLE NETWORK SYSTEM

(71) Applicant: DENSO CORPORATION, Kariya-city (JP)

(72) Inventors: SHO MATSUMOTO, Kariya-city (JP); TOMOHISA KISHIGAMI, Kariya-city (JP); YOUICHI HAYASE, Kariya-city (JP)

(21) Appl. No.: 19/279,617

(22) Filed: Jul. 24, 2025

(30) Foreign Application Priority Data
Aug. 22, 2024 (JP) 2024-141173

(51) Int. Cl. G06F 11/10; H04L 12/40

(52) U.S. Cl. CPC G06F 11/1056; H04L 12/40039; H04L 2012/40273

(57) ABSTRACT

An in-vehicle network system is equipped to a vehicle, which includes multiple control devices communicating with one another via a communication bus. Each control device has cluster information indicating a cluster to which ego device belongs, and switches to an activated state or maintains the activated in response to receiving of network management message, which includes activation cluster information indicating a target cluster to be activated is same as the cluster of ego device. The in-vehicle network system is configured to: determine, when a rewrite request for rewriting the cluster information is received in at least one of the multiple control devices, that the rewrite request is a valid rewrite request under a condition that the rewrite request is within a rewritable range of the cluster information, and then rewrite the cluster information according to the valid rewrite request.

### CROSS REFERENCE TO RELATED APPLICATION

The present application claims the benefit of priority from Japanese Patent Application No. 2024-141173 filed on August 22, 2024. The entire disclosure of the above application is incorporated herein by reference.

### TECHNICAL FIELD

The present disclosure relates to an in-vehicle network system equipped to a vehicle. The in-vehicle network system includes multiple control devices that are connected to a communication bus and communicate with one another. The present disclosure also relates to a management method of the in-vehicle network system.

### BACKGROUND

Conventionally, an in-vehicle network system including an upper-level ECU, an intermediate ECU, and a lower-level ECU is known. In such an in-vehicle network system, the intermediate ECU is supplied with power from a power source, and supplies the power supplied from the power source to the lower-level ECU in response to receiving a message, which is transmitted from the upper-level ECU.

### SUMMARY

According to an aspect of the present disclosure, an in-vehicle network system equipped to a vehicle is provided. The in-vehicle network system includes at least one processor with a memory storing computer program code. The vehicle includes multiple control devices that are connected to a communication bus and communicate with one another via the communication bus. Each of the multiple control devices has cluster information indicating a cluster to which ego control device belongs among multiple clusters classified in advance. Each of the multiple control devices switches to an activated state or maintains the activated in response to receiving of a network management message, which is transmitted from another of the multiple control devices and includes activation cluster information indicating a target cluster to be activated is same as the cluster indicated by the cluster information of ego control device. The at least one processor with the memory may be configured to cause the in-vehicle network system to: determine, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and rewrite the cluster information in accordance with the valid rewrite request.

### BRIEF DESCRIPTION OF DRAWINGS

Features of the present disclosure will become apparent from the following detailed description made with reference to the accompanying drawings. In the drawings:

FIG. 1 is a diagram showing a configuration example of an in-vehicle network system according to an embodiment of the present disclosure;

FIG. 2 is an explanatory diagram for explaining an implementation method of a partial networking in which partial lower-level ECUs are set to activated states and remaining lower-level ECUs are set to sleep states based on NM messages generated by upper-level ECUs and PNC setting information included in each lower-level ECU;

FIG. 3 is a flowchart showing a process of adding or changing a start condition of a lower-level ECU in an in-vehicle network system;

FIG. 4 is a diagram showing an example of a range within which the PNC setting information can be changed according to an attribute of change request source of the PNC setting information;

FIG. 5 is a diagram showing an example of PNC setting information set in one of the lower-level ECUs before the PNC setting information is changed;

FIG. 6 is a diagram showing an example of PNC setting information included in a PNC change request, which requests a change in a lower-level ECU having the PNC setting information shown in FIG. 5;

FIG. 7 is a diagram showing PNC setting information after change, which is changed based on the PNC setting information before change as shown in FIG. 5 and a change request of the PNC setting information as shown in FIG. 6; and

FIG. 8 is a flowchart showing an example of a process for changing a rewritable range of PNC setting information.

### DETAILED DESCRIPTION

In a known in-vehicle network system described above, the intermediate ECU is supplied with power from a power source, and supplies the power supplied from the power source to the lower-level ECU in response to receiving a message, which is transmitted from the upper-level ECU. The intermediate ECU keeps the lower-level ECU in a power-off state until receiving of a message from the upper-level ECU. In response to the intermediate ECU receiving a message from the upper-level ECU, the lower-level ECU is supplied with power from the power source. When the lower-level ECU is supplied with the power, the lower-level ECU switches from a power-off state to a standby state in which the lower-level ECU waits for an instruction.

In the in-vehicle network system according to a related art, a special purpose ECU (for example, an intermediate ECU) is configured to manage the status of other ECUs (for example, lower-level ECUs).

In recent years, after a vehicle has been sold and released onto the market, it is possible for a vehicle user to update software of an ECU (also referred to as control device) installed in the vehicle by downloading an application. In this case, depending on the functions of the downloaded application, the ECU whose software has been updated may be required to start up in response to satisfaction of a different condition, in addition to or instead of, a startup condition set before the software is updated.

In the in-vehicle network system according to a related art, the relationship between other ECUs and the special purpose ECU that manages the status of other ECUs is a fixed relationship, making it difficult to flexibly respond to changes in the startup conditions of other ECUs. When changes to the ECU startup conditions are permitted with not limitation, there is a risk that inappropriate changes may be made to important vehicle functions. As a result, the ECU may fail to start up when it should start up, and the vehicle may fail to perform necessary or important functions.

According to an aspect of the present disclosure, an in-vehicle network system equipped to a vehicle is provided. The in-vehicle network system includes at least one processor with a memory storing computer program code. The vehicle includes multiple control devices that are connected to a communication bus and communicate with one another via the communication bus. Each of the multiple control devices has cluster information indicating a cluster to which ego control device belongs among multiple clusters classified in advance. Each of the multiple control devices switches to an activated state or maintains the activated in response to receiving of a network management message, which is transmitted from another of the multiple control devices and includes activation cluster information indicating a target cluster to be activated is same as the cluster indicated by the cluster information of ego control device. The at least one processor with the memory is configured to cause the in-vehicle network system to: determine, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and rewrite the cluster information in accordance with the valid rewrite request.

According to another aspect of the present disclosure, a computer-implemented management method for managing an in-vehicle network system equipped to a vehicle is provided. The vehicle includes multiple control devices connected to a communication bus and the multiple control devices communicate with one another via the communication bus. Each of the multiple control devices has cluster information indicating a cluster to which ego control device belongs among multiple clusters classified in advance. Each of the multiple control devices switches to an activated state or maintains the activated in response to receiving of a network management message, which is transmitted from another of the multiple control devices and includes activation cluster information indicating a target cluster to be activated is same as the cluster indicated by the cluster information of ego control device. The management method includes: determining, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and rewriting the cluster information in accordance with the valid rewrite request.

In the above-described in-vehicle network system and the management method of the in-vehicle network system according to the present disclosure, each of the multiple control devices has the cluster information indicating the cluster to which ego device belongs among the multiple clusters. The multiple clusters are classified in advance. Each of the multiple control devices is configured to switch to or maintain the activated state when the network management message transmitted from another control device includes the activation cluster information indicating a target cluster to be activated is same as the cluster indicated by the cluster information of ego device.

According to the in-vehicle network system and the management method of the in-vehicle network system disclosed in the present disclosure, the cluster information of each control device is rewritable. Therefore, each control device can flexibly respond to an addition to the start-up condition or a change in the start-up condition.

According to the in-vehicle network system and the management method of in-vehicle network system disclosed in the present disclosure, when a rewrite request that requests rewrite of the cluster information is received, the rewrite request within the rewritable range of cluster information is determined as a valid rewrite request. Herein, the rewritable range of cluster information is set according to the attributes of the source that transmitted the rewrite request. The cluster information is rewritten in accordance with the rewrite request that is determined to be valid. With the in-vehicle network system and the management method of the in-vehicle network system according to the present disclosure, rewriting of the cluster information is performed only within the rewritable range of cluster information, which is set according to the attribute of the rewrite request source. Thus, it is possible to effectively suppress occurrence of an inappropriate change, which may lead to addition or modification of an invalid start-up condition of the control device related to an important vehicle function.

The following will describe an embodiment of an in-vehicle network system and a management method of in-vehicle network system according to the present disclosure with reference to the drawings. The present disclosure is not limited to the following embodiments, and various modified examples described below are also included in the technical scope of the present disclosure. In addition to the following embodiment, various modifications can be made without departing from the spirit and scope of the present disclosure. The embodiments and various modified examples can be combined within a scope that does not cause technical inconsistency. In the following description, the same or similar components may be denoted by the same reference symbol throughout the drawings, and descriptions thereof may be omitted. In addition, in a case where only a part of the configuration is referred to in an embodiment or modification example, the description in the foregoing embodiment may be applied to the remaining configuration.

### First Embodiment

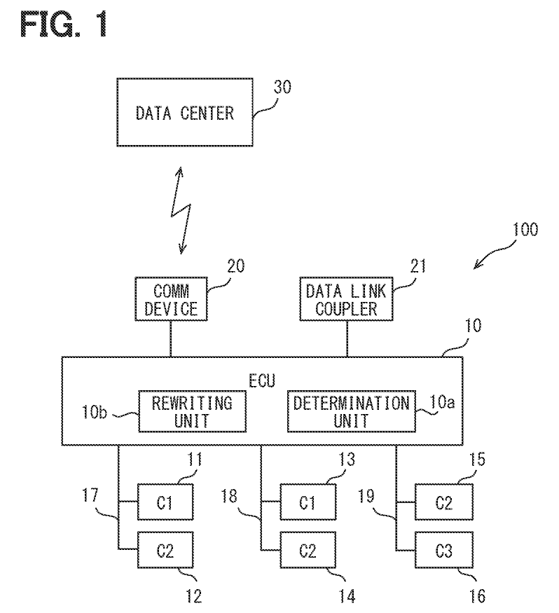

FIG. 1 is a diagram showing a configuration example of an in-vehicle network system 100 according to the present embodiment. As shown in FIG. 1, the in-vehicle network system 100 includes an upper-level ECU 10 and lower-level ECUs 11 to 16. The ECU is an abbreviation for electronic control unit, which is also known as an electronic control device. The upper-level ECU 10 may function as a domain controller that controls the lower-level ECUs 11 to 16. A domain refers to a functional unit when vehicle functions are broadly divided into a powertrain domain, a chassis domain, an advanced driver assistance domain, a body domain, a cockpit domain, and the like. For example, when a controller of powertrain domain is implemented by the upper-level ECU 10, the lower-level ECUs include various ECUs for controlling the powertrain of the vehicle, such as an engine ECU, a motor (inverter) ECU, a battery monitoring ECU, and a transmission ECU. When a controller of chassis domain is implemented by the upper-level ECU 10, the lower-level ECUs include various ECUs for controlling the chassis of vehicle, such as a steering ECU, a brake ECU, and a suspension ECU.

The above is an example for dividing the functional domains, and the domains divided in accordance with the function may be different from the above-described example. The upper-level ECU 10 may be an area controller that controls the lower-level ECUs 11 to 16 arranged in respective areas of the vehicle. Although FIG. 1 shows an example in which the in-vehicle network system 100 has one upper-level ECU 10, the in-vehicle network system 100 may be configured to have multiple upper-level ECUs that are connected to one another so that the multiple upper-level ECUs can communicate with one another. In this case, the multiple upper-level ECUs may be connected to one another so as to be able to communicate with one another via, for example, a gateway ECU.

The in-vehicle network system 100 can use CAN (registered trademark, the same applies below) as a communication protocol. CAN is an abbreviation of Controller Area Network. The communication protocol is not limited to CAN, and the in-vehicle network system 100 may employ another communication protocol, such as CAN-FD (CAN with Flexible Data Rate). In the present embodiment, the in-vehicle network system 100 is configured to be capable of implementing network management. The network management switches each of the lower-level ECUs 11 to 16 between a normal operation mode (activated state) and a power saving mode (sleep state) for each group (also referred to as a cluster). Each group includes at least one lower-level ECU. Therefore, the communication protocol adopted in the in-vehicle network system 100 is required to be compatible with the network management.

In the example shown in FIG. 1, a first communication bus 17, a second communication bus 18, and a third communication bus 19 are connected to the upper-level ECU 10. FIG. 1 shows an example in which three communication buses 17, 18, 19 are connected to the upper-level ECU 10. However, the number of communication buses connected to the upper-level ECU 10 is not limited to the example and may be two or less, or may be four or more.

In FIG. 1, the first communication bus 17 is connected to the lower-level ECU 11 and the lower-level ECU 12. The second communication bus 18 is connected to the lower-level ECU 13 and the lower-level ECU 14. The third communication bus 19 is connected to the lower-level ECU 15 and the lower-level ECU 16. The number of the lower-level ECUs 11, 12, 13, 14, 15, 16 connected to each of the communication buses 17, 18, 19 may be one, or three or more.

For example, each of the lower-level ECUs 11 to 16 is a control ECU for controlling a predetermined control target in the vehicle, or a sensor ECU for calculating a predetermined physical quantity based on a detection signal detected by a sensor. When it is necessary to control a control target or when it is necessary to calculate a predetermined physical quantity based on a detection signal from a sensor, each of the lower-level ECUs 11 to 16 is switched to an activated state in a normal operation mode and performs a normal operation. When there is no need for such operation, each of the lower-level ECUs 11 to 16 switches to a sleep state in a power saving mode.

To switch between the activated state and the sleep state, each of the lower-level ECUs 11 to 16 has cluster information (also referred to as PNC setting information) that indicates the cluster to which ego ECU belongs among multiple clusters. The PNC setting information is information for grouping the lower-level ECUs, which are required to be activated simultaneously when executing at least one predetermined function in the vehicle, within the same cluster. The PNC setting information will be explained in detail later. PNC is an abbreviation for Partial Networking Clustering.

The upper-level ECU 10 may function as a domain controller, and controls the lower-level ECUs 11 to 16. The upper-level ECU 10 may have a function of switching control between the activated state and the sleep state of each lower-level ECUs 11 to 16. Specifically, the upper-level ECU 10 determines a function to be executed in the vehicle. In response to determining that a predetermined function needs to be executed, the upper-level ECU 10 switches the lower-level ECUs, which need to be activated simultaneously to execute the predetermined function, to activated states. When switching the lower-level ECU to the activated state, the upper-level ECU 10 generates a network management message (also referred to as NM message) and transmits the generated NM message to the lower-level ECUs via each communication bus 17, 18, 19. The NM message includes activation cluster information (also referred to as PN request information) that designates a cluster to be activated. The cluster is a group of one or more lower-level ECUs that need to be activated simultaneously. In the above description, the upper-level ECU 10 determines a function to be executed in the vehicle and transmits the NM message including the PN request information. Alternatively, one of the lower-level ECUs 11 to 16 may determine a function to be executed in the vehicle and transmit the NM message including the PN request information to another lower-level ECU. When the vehicle is provided with multiple upper-level ECUs and multiple lower-level ECUs depending on respective upper-level ECUs, the NM message may be transmitted from another upper-level ECU or another lower-level ECU.

The upper-level ECU 10 executes a process for relaying a message between a lower-level ECU connected to one of the communication buses 17 to 19 and a lower-level ECU connected to another one of the communication buses. When each of the lower-level ECUs 11 to 16 is in an activated state and performing normal operation, each of the lower-level ECUs transmits a message for cooperative control with other lower-level ECUs 11 to 16 and transmits the NM message indicating that ego ECU is in an activated state. These messages transmitted from the lower-level ECU can be relayed via the upper-level ECU 10 to another lower-level ECU connected to any one of the communication buses 17 to 19. The upper-level ECU 10 may enter a sleep state when all of the lower-level ECUs 11 to 16 belonging to all clusters enter sleep states.

One of the ECUs included in the in-vehicle network system 100 is connected to an exterior communication device (COMM DEVICE) 20 capable of wirelessly communicating with an external server, such as a data center 30. FIG. 1 shows an example in which the exterior communication device 20 is connected to the upper-level ECU 10. The exterior communication device 20 may be connected to an ECU other than the upper-level ECU 10, or may be equipped to any one of the multiple ECUs. For example, the upper-level ECU 10 can download, via the exterior communication device 20, from the data center 30, an application for implementing a new function in the vehicle or update program for upgrading program already installed in at least one of the lower-level ECUs 11 to 16. The application and update program may be provided by the vehicle manufacturer (original equipment manufacturer, OEM) or a third party.

One of the ECUs in the in-vehicle network system 100 may have a data link coupler 21 to which a data device (not shown) is connected. FIG. 1 shows an example in which the data link coupler 21 is connected to the upper-level ECU 10. The data link coupler 21 may be connected to an ECU other than the upper-level ECU 10, or may be equipped to any of the ECUs. Similar to the data center 30, the data device is capable of providing applications for implementing new functions, update program for upgrading installed program, and the like.

The upper-level ECU 10 and the lower-level ECUs 11 to 16 each may be configured by a computer including a processor, a memory, a non-transitory storage, and the like. For example, the processor is a CPU (Central Processing Unit), an MPU (Micro Processing Unit), a GPU (Graphics Processing Unit), or a DFP (Data Flow Processor), each of which is capable of executing a predetermined process according to a program. The memory is a volatile storage medium, such as a RAM (Random Access Memory), that temporarily stores results of arithmetic processing executed by the processor. The storage includes non-volatile storage media such as flash memory and ROM (Read Only Memory). The storage stores various data and programs executed by the processor. Partial or all of the functions of the upper-level ECU 10 may be implemented by hardware circuit using, for example, an ASIC (Application Specific Integrated Circuit) or an FPGA (Field-Programmable Gate Array). FIG. 1 shows a determination unit 10a and a rewriting unit 10b, which are functional units that can be implemented software manner and/or hardware manner in the upper-level ECU 10. The determination unit 10a and the rewriting unit 10b will be described in detail later.

The upper-level ECU 10 and the lower-level ECUs 11 to 16 each includes a communication interface (communication IF) for communicating with other ECUs. For example, in each lower-level ECU, when the communication IF receives the NM message in the sleep state, the communication IF has a function of temporarily switching the lower-level ECU from the sleep state to the activated state in response to the reception of the NM message. When each lower-level ECU 11 to 16 is temporarily activated by the communication IF, each lower-level ECU determines whether activation of ego ECU is requested based on the PN request information and the PNC setting information included in the NM message. In response to determining that activation of ego ECU is requested, the lower-level ECU continues the activated state. In response to determining that the activation request is not for the ego ECU, the lower-level ECU 11 to 16 enters the sleep state again. The determination based on the PN request information of the NM message and the PNC setting information may be configured to be executed by the communication IF. In this case, when the communication IF determines that activation is requested based on the PN request information and the PNC setting information, the communication IF switches the corresponding ECU from the sleep state to the activated state.

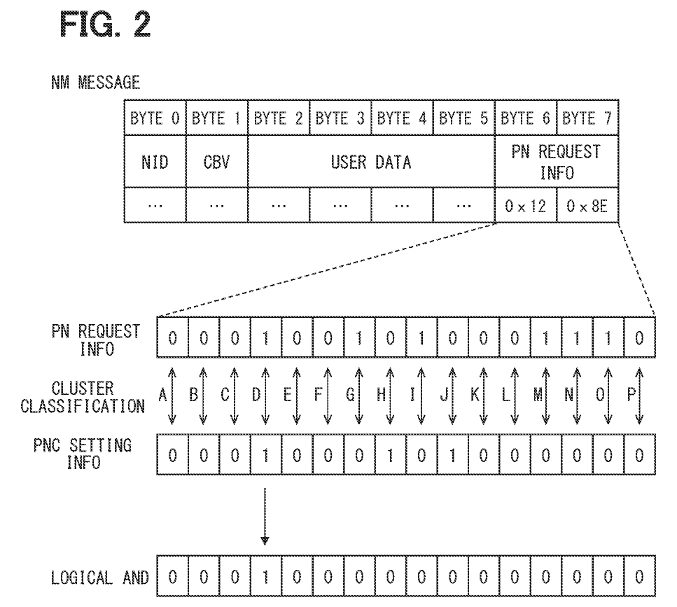

The following will describe the NM message generated by the upper-level ECU 10, the PNC setting information in each of the lower-level ECUs 11 to 16, and an exemplary method for implementing the partial networking with reference to FIG. 2. In the partial networking, partial lower-level ECUs are activated and remaining lower-level ECUs maintain the sleep states based on the NM message generated by the upper-level ECU 10 and the PNC setting information in each of the lower-level ECUs 11 to 16.

The NM message includes, for example, data from byte 0 to byte 7 as shown in FIG. 2. Byte 0 contains the node ID (NID). The node ID is an identifier set to each of the upper-level ECU 10 and the lower-level ECUs 11 to 16. The node ID enables identification of a transmission source of the NM message. Byte 1 contains Control Bit Vector (CBV). The control bit vector is data that indicates whether partial networking is used or not. When the control bit vector indicates the use of partial networking, the user data area of bytes 2 to 7 contains the PN request information, which is activation cluster information indicating the cluster to be activated.

In the example shown in FIG. 2, the control bit vector indicates the use of partial networking and the PN request information is stored in bytes 6 and 7 of the user data area. The user data area from byte 2 to byte 5 can be used to transmit any information, such as a wake-up trigger or information on normality or abnormality. FIG. 2 shows exemplary format of the NM message. The NM message may have another format under a condition that the NM message includes information indicating whether the partial networking is used or not and the PN request information.

The PN request information indicates, for each of multiple clusters, the cluster that is required to be started and the clusters that is not required to be started. More specifically, in the example shown in FIG. 2, the multiple ECUs are classified into 16 clusters in advance. The PN request information includes 16-bit data respectively corresponding to the 16 clusters. That is, the 16-bit data of the PN request information is previously associated with the 16 clusters. When a bit in 16-bit data of the PN request information is "0", the data indicates that startup of the corresponding cluster is not required. When a bit in 16-bit data of the PN request information is "1", the data indicates that startup of the corresponding cluster is required.

As described above, each of the lower-level ECUs 11 to 16 has the PNC setting information that indicates the cluster to which ego ECU belongs among the multiple clusters. An example of the PNC setting information is shown in FIG. 2. FIG. 2 shows the PNC setting information in one of the lower-level ECUs 11 to 16. In the PNC setting information shown in FIG. 2, when the associated clusters are classified as A to P from left to right in FIG. 2, the PNC setting information in FIG. 2 indicates that the lower-level ECU having the PNC setting information belong to clusters D, H, and J. Each of the lower-level ECUs 11 to 16 can perform various functions by executing programs, and can therefore belong to one or more clusters.

When each of the lower-level ECUs 11 to 16 receives the NM message including the PN request information via the communication IF, as shown in FIG. 2, each lower-level ECU compares the PN request information with the PNC setting information bit by bit and calculates, for example, a logical AND. That is, when the NM message is received via the communication IF, each of the lower-level ECUs 11 to 16 is temporarily switched to the activated state. Then, each of the lower-level ECUs 11 to 16 determines whether the cluster requested to be activated by the PN request information included in the NM message transmitted from the upper-level ECU 10 matches the cluster set in the PNC setting information. For example, in the example shown in FIG. 2, the clusters for which activation is requested by the PN request information include clusters D, G, I, M, N, and O. The clusters to which the lower-level ECU belongs, as indicated by the PNC setting information, are clusters D, H, and J. In this case, for the cluster D, the cluster requested to be started by the PN request information included in the NM message matches the cluster set in the PNC setting information. Therefore, the calculation result of logical AND is "1" in cluster D, as shown in FIG. 2.

When a bit becomes "1" as the calculation result of logical AND, the ECU having the PNC setting information shown in FIG. 2 determines that startup of ego ECU is requested. In response to this determination result, the ECU having the PNC setting information shown in FIG. 2 switches to the activated state if the previous state is the sleep state, and maintains the activated state if the previous state is the activated state. When the result of logical AND shows none of the bits are "1" and all are "0", the ECU having the PNC setting information shown in FIG. 2 determines that startup of ego ECU is not requested. In this case, the ECU having the PNC setting information shown in FIG. 2 discards the received NM message, and returns to the sleep state again if the previous state is the sleep state.

Each of the lower-level ECUs 11 to 16 executes filtering process based on the PNC setting information to determine whether the NM message is a request to start up the ego ECU. By executing the filtering process based on the PNC setting information, only when the cluster for which the activation is required by the PN request information matches the cluster included in the PNC setting information, the corresponding ECU having the PNC setting information is switched to the activated state in response to receiving the NM message, thereby realizing the partial networking.

For example, FIG. 1 shows an example in which the lower-level ECUs 11 and 13 are grouped into a cluster C1, the lower-level ECUs 12, 14, and 15 are grouped into a cluster C2, and the lower-level ECU 16 is grouped into a cluster C3. For example, when the upper-level ECU 10 transmits a NM message including PN request information that designates the cluster C1 as the cluster to be activated, the NM message causes the lower-level ECUs 11 and 13 to enter the activated state, but remaining lower-level ECUs 12, 14 to 16 are maintained in the sleep states. As a result, only the lower-level ECUs 11 and 13 are switched to the activated states, and remaining lower-level ECUs 12, 14 to 16 are maintained in the sleep states, thereby realizing the partial networking.

When each of the lower-level ECUs 11 to 16 is activated and switches to the normal operation mode, each lower-level ECU periodically transmits the NM message to other ECUs during the normal operation mode. Then, after performing the necessary processing, each of the lower-level ECUs 11 to 16 stops periodic transmission of NM message when it becomes unnecessary to execute the normal operation. When a duration during which one of the lower-level ECUs 11 to 16 do not receive the NM message from another ECU belonging to the same cluster reaches a predetermined standby time period, the lower-level ECU switches from the normal operation mode to the power saving mode, and switches from the activated state to the sleep state.

In recent years, after a vehicle has been sold and released onto the market, it is possible for a vehicle user to update software of an ECU installed in the vehicle by downloading an application. In this case, it may be necessary to add or change a start condition of the ECU whose software has been updated, depending on the function of the downloaded application. However, if unlimited addition or change to the ECU startup condition is permitted, there is a risk that an invalid change may be made to the ECU, and the ECU may fail to properly start up when it should start up. As a result, the ECU may fail to provide some important vehicle functions.

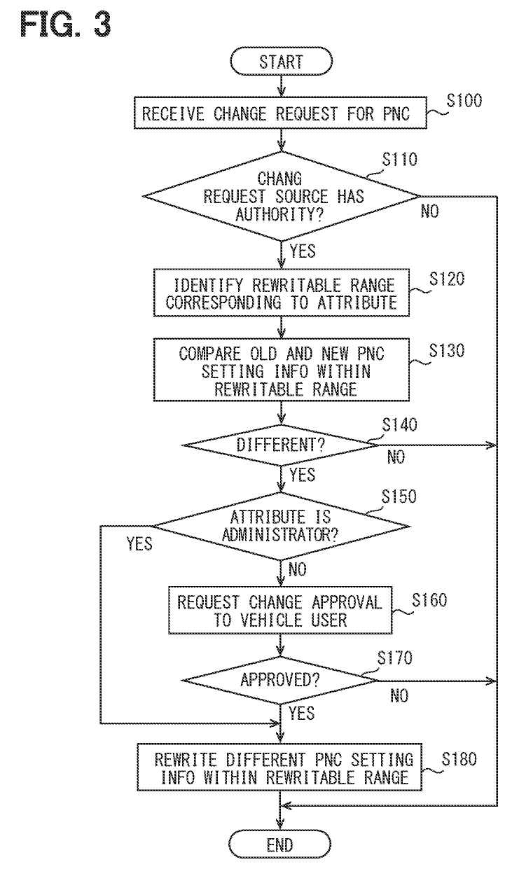

The in-vehicle network system 100 of the present embodiment is configured to enable flexible response to addition of start condition or change to the startup condition in each of the lower-level ECUs 11 to 16, while preventing invalid change to the startup conditions of the lower-level ECUs 11 to 16 related to the important functions. The process for adding or changing the startup conditions of the lower-level ECUs 11 to 16 in the in-vehicle network system 100 will be described below with reference to the flowchart of FIG. 3. Execution of the process shown in the flowchart of FIG. 3 corresponds to execution of a management method of in-vehicle network system according to the present embodiment.

The process shown in the flowchart of FIG. 3 may be executed by the upper-level ECU 10. The process shown in the flowchart of FIG. 3 may also be executed by an external device placed outside the vehicle, for example, by the data center 30 or the data device connected to the data link coupler 21. When the process is executed outside the vehicle, there is a concern that the amount of communication required for rewriting the PNC setting information may increase. Therefore, it is proper to perform the process in an ECU provided within the vehicle. For example, when the upper-level ECU 10 is configured to collectively receive requests to rewrite the PNC setting information, the amount of communication data required for rewriting the PNC setting information can be reduced.

A part of the process shown in the flowchart of FIG. 3 may be executed by the upper-level ECU 10, and the remaining process may be executed by at least one of the lower-level ECUs 11 to 16. For example, the rewriting process in S180 to be described later may be executed by the upper-level ECU 10, and the remaining portion may be executed by at least one of the lower-level ECUs 11 to 16. In the following description, an example in which the upper-level ECU 10 executes the process shown in the flowchart of FIG. 3 will be described.

In S100, the upper-level ECU 10 receives a change request (hereinafter also referred to as rewrite request) for rewriting the PNC setting information of at least one of the lower-level ECUs 11 to 16 from the data center 30 or a data device connected to the data link coupler 21. The change request that requests change of the PNC setting information is transmitted from the data center 30 or the data device, which is connected to the data link coupler 21, to the upper-level ECU 10 together with an application when the vehicle user downloads an application from the data center 30 or the data device connected to the data link coupler 21. The rewrite request of PNC setting information includes at least information indicating an attribute of request source, which requests the rewrite of PNC setting information, and PNC setting information after change. The PNC setting information after change is also referred to as change request PNC setting information.

At least one of the lower-level ECUs 11 to 16 that executes the downloaded application may need to add or change a start condition depending on the function of the downloaded application. For example, suppose a vehicle is equipped with a camera that is used for advanced driver assistance functions, such as lane keep assist and obstacle detection while the vehicle is traveling. A vehicle user may download an application for implementing a monitoring function for monitoring a periphery of the vehicle and a periphery of residence, using the vehicle camera while the vehicle is in parked state. In this case, the camera is required to operate not only when the vehicle is traveling, but also when the vehicle is in parked state. One of the lower-level ECUs 11 to 16 which control the camera is required to be in an activated state not only when the vehicle is traveling but also when the vehicle is in the parked state.

The start condition of the lower-level ECU can be changed by the above-described PNC setting information. Therefore, the data center 30 or the data device transmits a request to the upper-level ECU 10 as necessary to change the PNC setting information already set in the corresponding lower-level ECU that executes the downloaded application.

In S110, the upper-level ECU 10 determines, based on the received PNC change request, whether the change request source that requests the change of PNC setting information has an authority to change the PNC setting information. When the upper-level ECU 10 determines that the change request source has the authority to change the PNC setting information, the upper-level ECU 10 proceeds to S120. When the upper-level ECU 10 determines that the change request source does not have the authority to change the PNC setting information, the upper-level ECU 10 ends the process shown in the flowchart of FIG. 3.

Depending on whether the downloaded application is prepared by a vehicle manufacturer (also referred to as OEM) or a third party other than the OEM, the PNC change request may include identifier information indicating whether the change request source is an OEM or a third party, as information indicating the attribute of change request source that requests change of the PNC setting information. When the change request source is a third party, the PNC setting information may include identifier information for identifying whether the third party is a certified third party certified by the OEM or an uncertified third party that is not certified by the OEM. The PNC change request may further include a passcode according to the attribute of each change request source in addition to the identifier information indicating the change request source.

In S110, when the PNC change request includes the identifier information indicating an OEM or a third party, or the PNC change request includes a passcode corresponding to the OEM or a third party, the upper-level ECU 10 can determine that the change request source has the authority to change the PNC setting information. When the PNC change request does not include the identifier information nor a passcode, the upper-level ECU 10 can determine that the PNC change request is invalid and that the change request source does not have the authority to change the PNC setting information.

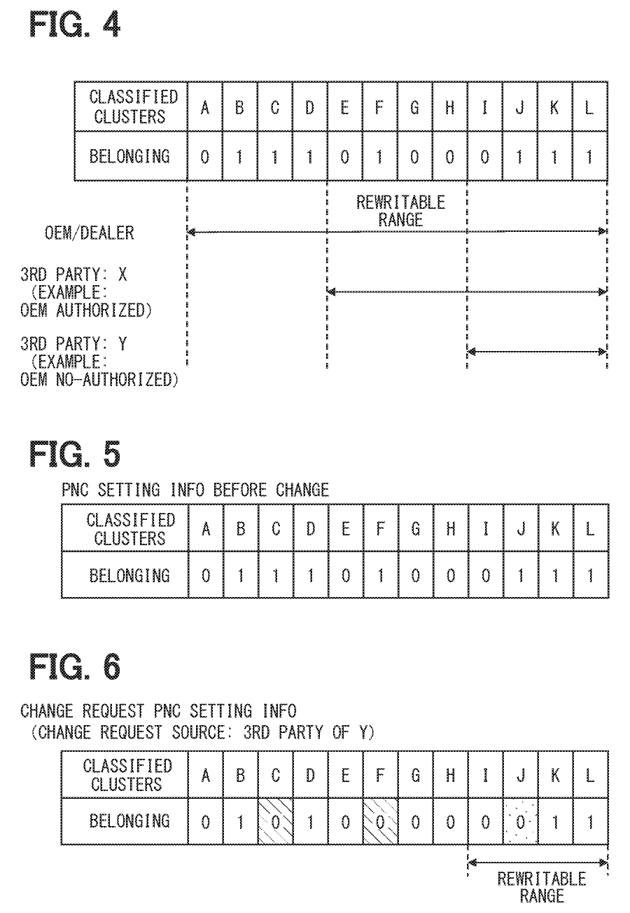

In S120, the upper-level ECU 10 specifies a change range of the PNC setting information according to the attribute of each request source, based on the identifier information included in the PNC change request. An example of the change range of the PNC setting information according to the attribute of change request source will be described below with reference to FIG. 4. FIG. 4 shows an example in which the multiple ECUs are classified into 12 clusters. The 12 clusters are classified into cluster A to cluster L from the left to the right as shown in FIG. 4.

In the example shown in FIG. 4, when the downloaded application is prepared by the OEM and the change request source that requests the change of PNC setting information is the OEM (or dealer), the OEM (or dealer) has the authority to change the PNC setting information for all clusters A to L included in the PNC setting information, as an administrator. The OEM is familiar with the functions performed by all of the lower-level ECUs 11 to 16. For this reason, there is no risk of making an invalid change to the PNC setting information. Herein, invalid change refers to a change that may cause the lower-level ECUs 11 to 16 failing to start up when the lower-level ECUs 11 to 16 should start up in the vehicle.

In the example shown in FIG. 4, when the downloaded application is prepared by a third party X, which is a certified third party, and the change request source that requests a change to the PNC setting information is the third party X, the third party X has the authority to change the PNC setting information within a range of clusters E to L, excluding clusters A to D. In the example shown in FIG. 4, when the downloaded application is prepared by a third party Y, which is an uncertified third party, and the change request source that requests a change to the PNC setting information is the third party Y, the third party Y has the authority to change the PNC setting information within a range of clusters I to L, excluding clusters A to H. The authorized third party and/or the unauthorized third party do not necessarily have in-depth knowledge of the functions executed in all of the lower-level ECUs 11 to 16. Therefore, when the attribute of change request source is a certified third party and/or a non-certified third party, the change range of the PNC configuration information is limited to a range that does not impair important functions of the vehicle. With this configuration, it is possible to effectively suppress a change of PNC setting information, which may lead to addition or modification of an invalid start-up condition of each lower-level ECU 11 to 16 regarding important vehicle functions.

As described above with reference to FIG. 4, the rewritable range of PNC setting information can be set different according to the attribute of change request source of the PNC setting information. Specifically, the rewritable range of PNC setting information is defined, in advance, as at least two regions into which the clusters are classified. In the example shown in FIG. 4, cluster A to cluster L are classified into three regions. The cluster A to the cluster D are defined as one region, the cluster E to the cluster H are defined as one region, and the cluster I to the cluster L are defined as one region. The number of regions into which the clusters are classified may be two, or may be four or more.

The attribute of change request source of the PNC setting information includes a higher-level attribute with a broader scope of authority, such as the OEM (or dealer) who is the administrator. The attribute of change request source of the PNC setting information includes a lower-level attribute with a narrower scope of authority, such as a third party having lower authority than the OEM (or dealer). A part of the rewritable range (multiple regions of the clusters) corresponding to the change request source having the higher-level attribute may be set as the rewritable range (at least one region of the clusters) corresponding to the change request source having the lower-level attribute.

When classifying all of the clusters into two or more regions, the clusters may be classified based on a domain. Each cluster is a group of multiple lower-level ECUs 11 to 16 that need to be activated simultaneously in order to perform at least one predetermined function related to the vehicle. When various vehicle functions are broadly grouped into multiple domains, at least one predetermined function may be set to be included in one of the multiple domains. Therefore, each cluster can be classified into one of the multiple domains.

As described above, the domains may include the powertrain domain and the chassis domain, which are related to vehicle driving. The domains may also include the advanced driver assistance domain related to vehicle driving safety. When the PNC setting information for clusters included in the powertrain domain, the chassis domain, and the advanced driver assistance domain is changed erroneously, there is a risk that important functions such as vehicle driving and driving safety will be impaired. Therefore, when classifying all clusters into two or more regions, the clusters may be classified, for example, into a first region and a second region such that the first region includes all clusters and the second region excludes the clusters belonging to the powertrain domain, the chassis domain, and the advanced driver assistance domain.

When classifying all clusters into two or more regions, the importance of function executed by each lower-level ECU 11 to 16 grouped in the same cluster may be determined on a cluster-by-cluster basis. For example, the regions may be classified into a third region covering all clusters including a specific cluster that executes an important function, and a fourth region that does not include the specific cluster. The specific cluster may be a cluster for executing the functions related to vehicle driving and driving safety described above. When the vehicle is compatible with a well-known smart key or digital key, the specific cluster may be defined to include a key verification ECU or a digital key ECU. This is because the key verification ECU and the digital key ECU are activated at a valid time, thereby ensuring convenience for the user and ensuring security of the vehicle.

When classifying all of the clusters into two or more regions, the regions may be classified based on the amount of power consumption by the lower-level ECUs 11 to 16 belonging to each cluster. For example, the clusters may be classified into a fifth region, which includes all of the clusters including the clusters to which the lower-level ECUs 11 to 16 with relatively high power consumption belong, and a sixth region, which exclude the clusters to which the lower-level ECUs 11 to 16 with relatively high power consumption belong. Herein, a relatively high power consumption may be set to a power consumption equal to or higher than a predetermined level, and the predetermined level may be properly set according to power consumptions of multiple control devices equipped to the vehicle with further consideration of the capacity of vehicle battery. When the activation conditions are changed so that the cluster to which the lower-level ECUs 11 to 16 with relatively high power consumptions belong is activated more frequently, there is a high possibility of serious situation, such as battery depletion in the vehicle.

The above-described first and second regions classified based on domains, the third and fourth regions classified based on clusters, and the fifth and sixth regions classified based on the power consumption of lower-level ECUs 11 to 16 may be used individually or in combined manner.

The following will continue description of the flowchart shown in FIG. 3. In S130, the upper-level ECU 10 compares the bits of the PNC setting information before change with the bits of the change request PNC setting information within the rewritable range of the PNC setting information according to the attribute of the change request source of the PNC setting information. Specifically, the upper-level ECU 10 determines change request of bits within the rewritable range of the PNC setting information as valid change request (rewrite request), and determines change request of bits outside the rewritable range as invalid change request (rewrite request). The upper-level ECU 10 then compares the bits of the PNC setting information before change with the bits of the change request PNC setting information within the rewritable range of the PNC setting information corresponding to the change request that has been determined to be valid. That is, bits of the PNC setting information that are outside the rewritable range of the PNC setting information are ignored. As a result, the PNC setting information outside the rewritable range of the PNC setting information is discarded.

For example, FIG. 5 shows an example of the PNC setting information before change set in one of the lower-level ECUs 11 to 16. FIG. 6 shows an example of the PNC setting information included in the PNC change request, which requests the change of PNC setting information to the lower-level ECU having the PNC setting information shown in FIG. 5. As shown in FIG. 6, the attribute of change request source of the PNC change request is a third party Y, which is an uncertified third party.

As shown in FIG. 6, the rewritable range of PNC setting information, which is permitted for an unauthorized third party to change, is the range of clusters I to L. Therefore, in S130, the PNC setting information before change is compared with the change request PNC setting information within the range of clusters I to L for each bit. The bits within the clusters I to L correspond to bits of PNC setting information within the rewritable range. The bits associated with clusters A to H of the PNC setting information are ignored since they are outside the rewritable range.

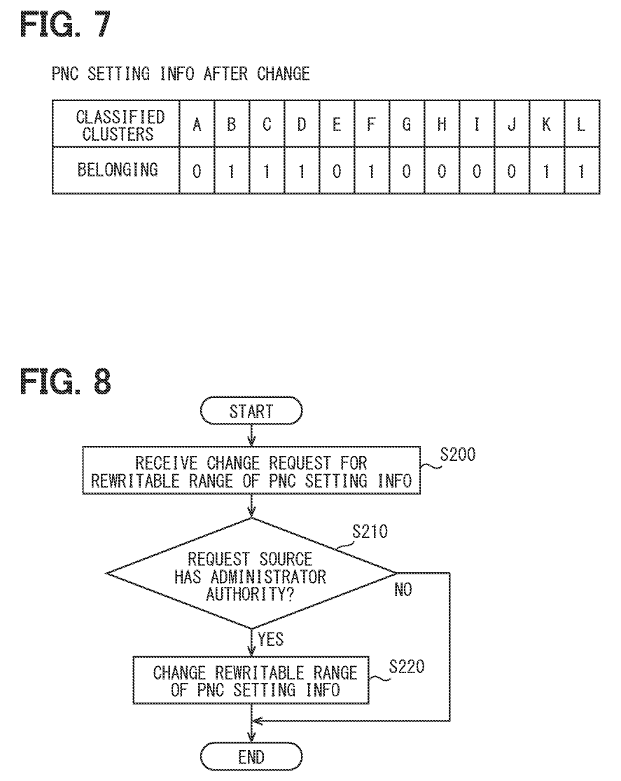

For example, in the change request PNC setting information shown in FIG. 6, the bits corresponding to clusters C and F with hatching lines and the bit corresponding to the cluster J with dotted pattern are different from the corresponding bits in the PNC setting information before change shown in FIG. 5. As described above, the cluster J belongs to the rewritable range. Therefore, as shown in FIG. 7, in the PNC setting information after change (rewritten PNC setting information), the bit corresponding to the cluster J is rewritten in response to the change request PNC setting information. On the other hand, the bits corresponding to the clusters C and F of the change request PNC setting information are ignored since they are outside the rewritable range. As a result, in the PNC setting information after change as shown in FIG. 7, the bits corresponding to the clusters C and F remain the same as the bits in the PNC setting information before change as shown in FIG. 5.

In the above example, when the change request PNC setting information includes not only PNC setting information within the rewritable range of the PNC setting information, but also PNC setting information outside the rewritable range, the PNC setting information before change is changed based on the PNC setting information within the rewritable range, and the change request PNC setting information outside the rewritable range is discarded. In another example, when the change request PNC setting information includes the PNC setting information outside the rewritable range, the change request including such change request PNC setting information may be determined to be invalid, and the change request PNC setting information may be discarded without making any changes to the PNC setting information. That is, the PNC setting information may be changed only when the change request of PNC setting information includes only PNC setting information within the rewritable range.

In S140, the upper-level ECU 10 determines, based on the comparison result, whether the bits of PNC setting information before change are different from the bits of change request PNC setting information within the rewritable range of the PNC setting information. In response to determining that there is a difference, the upper-level ECU 10 proceeds to S150. In response to determining that there is no difference, the upper-level ECU 10 ends the process shown in FIG. 3.

The above-described process executed in S110 to S140 corresponds to a process executed by the determination unit 10a, which is implemented by the upper-level ECU 10.

In S150, the upper-level ECU 10 determines whether the attribute of change request source of the PNC setting information is an OEM (or a dealer) having administrator authority. In response to determining that the attribute of change request source is an OEM (or a dealer) having administrator authority, the upper-level ECU 10 proceeds to S180. In response to determining that the attribute of change request source is a third party that does not have administrator authority, the upper-level ECU 10 proceeds to S160.

In S160, since the attribute of change request source of PNC setting information does not have administrator authority, the upper-level ECU 10 requests approval for the change of PNC setting information to the user or owner of the vehicle who has administrator authority. In S170, the upper-level ECU 10 determines whether the change of the PNC setting information is approved by the user of the vehicle. The process executed in S160 and S170 corresponds to a confirmation unit. This approval may be made by the vehicle user performing an operation indicating approval (such as a touch panel operation or voice operation) while, for example, entering an authentication code indicating that he or she is an administrator, on a screen of the vehicle infotainment system. Alternatively, approval may be made by using a mobile terminal carried by the vehicle user to perform short-range wireless communication with the upper-level ECU 10, transmitting an ID indicating that the user is the vehicle user, and performing an operation indicating approval for the change. In response to determining that the user approval is made, the upper-level ECU 10 proceeds to S180. In response to determining that the user approval is failed, the upper-level ECU 10 ends the process shown in the flowchart of FIG. 3.

In S180, the upper-level ECU 10 rewrites the bits of PNC setting information before change, which are different from the corresponding bits in the change request PNC setting information, such that the bits of PNC setting information are same as the corresponding bits of the change request PNC setting information within the rewritable range of the PNC setting information. The rewritable range of the PNC setting information is defined according to the attribute of the change request source of the PNC setting information. The process executed in S180 corresponds to a process executed by the rewriting unit 10b implemented by the upper-level ECU 10.

As described above, according to the in-vehicle network system and the management method of the in-vehicle network system described in the present embodiment, change (rewriting) of the PNC setting information is performed only within the rewritable range of the PNC setting information. Herein, the rewritable range of the PNC setting information is determined according to the attribute of the change request source (also referred to as rewrite request source). With this configuration, it is possible to effectively suppress a change of PNC setting information, which may lead to addition or modification of an invalid start-up condition of each lower-level ECU 11 to 16 regarding important vehicle functions.

### Modifications

One exemplary embodiment of the present disclosure is explained above. The present disclosure is not limited to the above-described embodiment, and can be implemented by various modifications without departing from the spirit of the present disclosure.

In one example, the rewritable range of PNC setting information, which is determined according to the attribute of the change request source of PNC setting information, may be configured to be changeable by a person having an administrator authority (such as an OEM or dealer, or a vehicle owner). An example of a process for changing the rewritable range of PNC setting information will be described with reference to the flowchart shown in FIG. 8.

In S200, the upper-level ECU 10 receives a change request of the rewritable range of the PNC setting information. The rewritable range of PNC setting information is set according to the attribute of the change request source of the PNC setting information. In S210, the upper-level ECU 10 determines whether the change request is made by a person having an administrator authority. The process executed in S210 corresponds to an authority determination unit. For example, whether the person request the change of rewritable range has the administrator authority can be determined based on a passcode or authentication code associated with the administrator. In response to determining that the person who requests change of rewritable range has the administrator authority, the upper-level ECU 10 proceeds to S210. In response to determining that the person who request change of rewritable range does not have the administrator authority, the upper-level ECU 10 ends the process shown in the flowchart of FIG. 8 without changing the rewritable range of the PNC setting information.

In S220, the upper-level ECU 10 changes the rewritable range of the PNC setting information based on the information indicating the rewritable range after change, which is included in the change request for rewritable range of the PNC setting information. The process executed in S220 corresponds to a changing unit.

The authentication code or ID indicating that the user is the vehicle user or owner may be configured to be changeable. With this configuration, when the user or owner of vehicle is changed by transferring the vehicle to another user or owner, it is possible to respond appropriately for the new user or owner.

What is claimed is:

1. An in-vehicle network system equipped to a vehicle, the in-vehicle network system comprising:
at least one processor with a memory storing computer program code, wherein
the vehicle includes multiple control devices that are connected to a communication bus and communicate with one another via the communication bus,
each of the multiple control devices has cluster information indicating a cluster to which ego control device belongs among multiple clusters classified in advance,
each of the multiple control devices switches to an activated state or maintains the activated state in response to receiving of a network management message, which is transmitted from another of the multiple control devices and includes activation cluster information indicating a target cluster to be activated is same as the cluster indicated by the cluster information of ego control device, and
the at least one processor with the memory is configured to cause the in-vehicle network system to:
determine, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and
rewrite the cluster information in accordance with the valid rewrite request.

2. The in-vehicle network system according to claim 1, wherein
the at least one processor with the memory is configured to determine the rewrite request that requests for rewrite of a range other than the rewritable range of the cluster information as an invalid rewrite request, and discards the invalid rewrite request.

3. The in-vehicle network system according to claim 1, wherein
the multiple clusters are classified into two or more regions,
rewritable ranges of the cluster information are set to be different from one another depending on an attribute of the rewrite request source, and
for the two or more regions, the rewritable ranges of the cluster information, which depend on the attribute of the rewrite request source, are set to be different from one another with the two or more regions as a reference.

4. The in-vehicle network system according to claim 3, wherein
the at least one processor with the memory is further configured to:
determine, in response to a change request for changing the rewritable range of the cluster information being made, whether the change request is made by a person having an administrator authority; and
change, in response to determining that the change request is made by the person having the administrator authority, the rewritable range of the cluster information, which is set according to the attribute of the rewrite request source.

5. The in-vehicle network system according to claim 3, wherein
the attribute of the rewrite request source includes a high-level attribute having a broad scope of authority and a low-level attribute having a narrow scope of authority,
the narrow scope of authority is set to have a narrower scope of authority than the broad scope of authority, and
a part of the rewritable range rewritable by the high-level attribute is set as the rewritable range rewritable by the low-level attribute.

6. The in-vehicle network system according to claim 5, wherein
the at least one processor with the memory is further configured to confirm with an owner of the vehicle whether the owner approves rewrite of the cluster information when the attribute of the rewrite request source is the low-level attribute, and
in response to confirming that the owner of the vehicle approved the rewrite of the cluster information, the at least one processor with the memory is configured to rewrite the cluster information.

7. The in-vehicle network system according to claim 6, wherein
the at least one processor with the memory is configured to require, in response to the owner of the vehicle approving the rewrite of the cluster information, authentication of the owner of the vehicle.

8. The in-vehicle network system according to claim 3, wherein
the cluster information is information for grouping one or more of the multiple control devices, which need to be activated simultaneously for implementing a predetermined function of the vehicle,
the predetermined function is set to belong to one of multiple domains into which various functions of the vehicle are divided, and
the multiple clusters are classified into the two or more regions based on the multiple domains of the vehicle.

9. The in-vehicle network system according to claim 3, wherein
the cluster information is information for grouping one or more of the multiple control devices, which need to be activated simultaneously for implementing a predetermined function of the vehicle, and
the multiple clusters are classified into the two or more regions such that the two or more regions include a first region that includes a specific cluster and a second region that does not include the specific cluster.

10. The in-vehicle network system according to claim 3, wherein
the cluster information is information for grouping one or more of the multiple control devices, which need to be activated simultaneously for implementing a predetermined function of the vehicle, and
the multiple clusters are classified into the two or more regions such that the two or more regions include a third region, which includes a cluster to which one of the multiple control devices with a relatively high power consumption belongs, and a fourth region, which does not include the cluster to which the one of the multiple control devices with the relatively high power consumption belongs.

11. The in-vehicle network system according to claim 1, wherein
the at least one processor with the memory configured to determine whether the rewrite request is the valid rewrite request is included in one of the multiple control devices.

12. The in-vehicle network system according to claim 1, wherein
the at least one processor with the memory configured to rewrite the cluster information is included in one of the multiple control devices.

13. A computer-implemented management method for managing an in-vehicle network system equipped to a vehicle, wherein the vehicle includes multiple control devices connected to a communication bus and the multiple control devices communicate with one another via the communication bus, each of the multiple control devices has cluster information indicating a cluster to which ego control device belongs among multiple clusters classified in advance, and each of the multiple control devices switches to an activated state or maintains the activated in response to receiving of a network management message, which is transmitted from another of the multiple control devices and includes activation cluster information indicating a target cluster to be activated is same as the cluster indicated by the cluster information of ego control device,
the management method comprising:
determining, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and
rewriting the cluster information in accordance with the valid rewrite request.

14. A computer-readable non-transitory storage medium storing a program to be executed by at least one processor of an in-vehicle network system equipped to a vehicle, the program comprising instructions for managing the in-vehicle network system, wherein the vehicle includes multiple control devices connected to a communication bus and the multiple control devices communicate with one another via the communication bus, each of the multiple control devices has cluster information indicating a cluster to which ego control device belongs among multiple clusters classified in advance, and each of the multiple control devices switches to an activated state or maintains the activated in response to receiving of a network management message, which is transmitted from another of the multiple control devices and includes activation cluster information indicating a target cluster to be activated is same as the cluster indicated by the cluster information of ego control device,
the instructions of program comprising:
determining, when a rewrite request for rewriting the cluster information is received in at least one of the multiple control devices, that the rewrite request is a valid rewrite request under a condition that the rewrite request is within a rewritable range of the cluster information, the rewritable range being set according to an attribute of a rewrite request source of the rewrite request; and
rewriting the cluster information in accordance with the valid rewrite request.
